(19) United States
(12) Patent Application Publication
(10) Pub. No.: US 2023/0022969 A1
(43) Pub. Date: Jan. 26, 2023

(54) STRAIN RELIEF FOR SHIELDED-CABLE PLUG CONNECTOR

(71) Applicant: HIRSCHMANN AUTOMOTIVE GMBH, Rankweil/Brederis (AT)

(72) Inventors: Marco WEISS, Rankweil (AU); Raphael HOOR, Feldkirch (AU)

(21) Appl. No.: 17/784,138

(22) PCT Filed: Dec. 16, 2020
(86) PCT No.: PCT/EP2020/086479

§ 371 Date: Jun. 10, 2022

(30) Foreign Application Priority Data
Jan. 6, 2020 (DE) 10 2020 100 095.2

(51) Int. Cl. H01R 4/20

(52) U.S. Cl. CPC H01R 4/20

(57) ABSTRACT

The invention relates to an assembly comprising a plug connector and a cable (1) which is connected thereto and which has an inner conductor (2), a shielding (3), an insulation (4) between the inner conductor (2) and the shielding (3), and a jacket (5) pot which surrounds the aforementioned components, wherein a sleeve is added between the insulation (4) and the shielding (3) at a free IT end section of the cable (1), and a tubular component surrounds the shielding (3) and the sleeve.

The invention relates to an assembly comprising a connector, a cable connected thereto, an inner conductor, a tubular shield, insulation between the inner conductor and the shield, a jacket surrounding these parts, a sleeve between the insulation and the shield at a free end portion of the cable, and a tubular part surrounding the shield and the sleeve, according to the features of the preamble of patent claim 1.

Such an embodiment of an assembly works well with produce a continuous shielding from the cable to a plug connector or mating plug connector that is connected to the shielded cable.

A generic assembly with a plug connector with a connected cable is known from DE 10 2009 016 227 [U.S. Pat. No. 8,323,055]. The invention relates to a plug connector with connection to a coaxial cable that is designed according to the preamble of patent claim 1. In this embodiment, the sleeve is a slotted part in order to enable the tubular part that is an outer sleeve, to be pushed on. The slotted part, more precisely the slotted sleeve, has a bead, and the tubular part, more precisely the outer sleeve, has a groove matching the bead for fastening to the sleeve. As a result, no crimping of the outer sleeve on the slotted sleeve can take place. The fastening of the outer sleeve on the cable therefore leaves something to be desired. Furthermore, the jacket overlies the braided outer conductor at an axial spacing, so that no tightness and no fastening of the plug connector to the sheath of the cable are given and also moisture can penetrate.

The object of the invention is therefore to improve an assembly of the type described above such that the described disadvantages are remedied. This ensures that, in the case of the cable with plug-in connectors and possibly also without such a plug-in connector, tensile and/or compressive forces acting on the assembly can be absorbed.

This object is achieved by the features of claim 1.

According to the invention, the sleeve is an unprotected support sleeve and the tubular part is an outer sleeve that, in addition to the shielding with the support sleeve, also surrounds a section of the jacket. In a further embodiment of the invention, the outer sleeve is a crimp sleeve that is crimped onto the jacket and/or the shield with support sleeve. In this case, crimping of the outer sleeve for the electrical connection between the support sleeve and the shield is produced along the electrically conductive support sleeve at a point. Viewed axially further to the rear, a second crimping of the outer sleeve that is independent of the first crimping (inner support sleeve for shielding) and is to be set independently of the first crimping (inner support sleeve for shielding), is done to create the strain relief from the cable material or jacket and thus makes possible a functional relief of the shielding crimp location. This makes it possible to avoid the effect of lateral or circular cable movements in the outgoing region from the cable directly at the crimping zone between the support sleeve and the shield. This type of support (lever) reduces the possible relative movements and forces between the outer sleeve, the shield and the support sleeve. This separate and thus better protection against movement from the contact zone is of decisive importance for functional safety. In production, the first and the further crimping can be produced simultaneously in one step with one and the same tool (same crimp geometry) or simultaneously with two tools (identical or different crimping geometries). Alternatively, the two crimpings can be done by one and the same tool one after the other or with two different tools one after the other. The same applies here with respect to the crimp geometries.

The outer sleeve can have a radially inwardly projecting ridge between end faces of the outer sleeve and the support sleeve and extends around the shield all the way to the insulation. Alternatively, a spacing (clearance) can be provided between the end faces of the outer sleeve and the support sleeve. For example, the shield can be passed through free space to such an extent that the shield extends in particular frustoconically. The shield is guided up to the outer free end of the support sleeve. The support sleeve can also be a crimp sleeve and crimped on the insulation. Preferably, the inner diameter of the portion of the outer sleeve is formed as a seat of the outer sleeve and the outer diameter of the shield on the support sleeve is formed to have the same dimension. The shielding is thus implemented via the entire cable end, optionally with plug-in connection (plug-in connector and mating plug-in connector).

In the following, the state of the art and the invention up to the beginning of the following description of the figures in this patent application are again reproduced in other words.

The invention relates to a strain relief for a plug connector arranged on a shielded cable. For this purpose, it is important that the shielding (for example a shielding braid or a shielding foil) of a cable (for example a coaxial cable or a twisted pair cable or the like) is connected, i.e. electrically contacted, to a housing of a plug connector that is electrically conductive. ?This is necessary in order to transmit a continuous shielding from the cable via the plug connector to a mating plug connector that is likewise connected to a shielded cable, and therefore to grind it through.

At the same time, a permanent mechanical fixing of the cable on the plug connector (and also on the mating plug connector on its cable) can be ensured so that tensile and/or compressive forces that can act on the cable and/or the (mating plug connector do not act on at least one contact partner of the (mating plug connector or the connection between the shielding of the cable and the housing of the (mating plug connector ?that can disadvantageously lead to an interruption of the electrical contacting.

A generic plug connector is known from DE 10 2009 016 227 [U.S. Pat. No. 8,323,055]. It describes a plug connector for connecting to a coaxial cable as described in the introductory paragraph of claim 1. In this arrangement the sleeve is annularly discontinuous to facilitate fitting it over the outer jacket. The slit part or sleeve has a groove so that a complementary nut can be fitted over it to secure it in place. Thus the outer sleeve can be crimped over the slotted sleeve. Securing the outer sleeve to the cable is therefore freely done. In addition the jacket is thus axially spaced from the conductive outer shield braid so that there is no sealing and no securing of the plug connector to the sleeve of the cable and moisture can enter.

This problem is addressed by the features of claim 1.

According to the invention, the sleeve is as an unprotected inner support sleeve and that the tubular component is designed as an outer sleeve that, in addition to the shield with the inner support sleeve, also surrounds an end section of the jacket. In a further embodiment of the invention, the outer sleeve is designed as a crimp sleeve crimped onto the jacket and/or the shield with support sleeve. In this case, crimping of the outer sleeve for the electrical connection between the support sleeve and the shield is effected along the electrically conductive support sleeve at a location. Viewed further to the rear in the axial direction, a second crimping of the outer sleeve, which is independent of the first crimping (supporting sleeve for shielding) and is to be set independently of the first crimping (supporting sleeve for shielding), is carried out, which creates the strain relief from the cable or jacket and thus a functional relief of the shielding crimp location is made possible. This makes it possible to avoid lateral or circular cable movements in the outgoing region from the cable form having an effect directly to the crimp zone between the support sleeve and the shield. This type of support (lever) reduces the possible relative movements and forces between the outer sleeve, the shield and the support sleeve. This separate and thus better protection against movement from the contact zone is of decisive importance for functional safety. In production, the first and the further crimping can be produced simultaneously in one step with one and the same tool (same crimp geometry) or simultaneously with two tools (identical or different crimping geometries). Alternatively, the two crimpings can be done with one and the same tool one after the other or with two different tools one after the other. The same applies here with respect to the crimp geometries.

The outer sleeve can have a radially inwardly projecting ridge between end faces of the outer sleeve and the inner support sleeve and extending around the shield all the way to the insulation. Alternatively, a spacing (clearance) can be provided between the end faces of the outer sleeve and the support sleeve. For example, the shield can be inserted into this free space to such an extent that the shield is in particular frustoconical. The shield extends as far as the outer free end of the support sleeve. The support sleeve can also be designed as a crimp sleeve and crimped on the insulation. Preferably, the diameter of the portion of the jacket is formed as a seat of the outer sleeve and the outer diameter of the shield on the inner support sleeve is formed to have the same dimension. The shielding thus extends along the entire cable end, optionally with plug-in connection (plug-in connector and mating plug-in connector).

In the following, the state of the art and the invention is again reproduced in other words up to the beginning of the following description of the figures in this patent application.

The invention relates to a strain relief for a plug connector mounted on a shielded cable. For this purpose, it is important that the shielding (for example a shielding braid or a shielding foil) of a cable (for example a coaxial cable or a twisted-pair cable or the like) is connected, i.e. electrically contacted, to a housing of a plug connector that is electrically conductive. This is necessary in order to provide continuous shielding from the line via the plug connector to a mating plug connector that is also likewise connected to a shielded line, and therefore to connect it through.

At the same time, a permanent mechanical arrangement of the conductor on the plug connector (and also on the mating plug connector on its line) can be ensured so that tensile and/or compressive forces acting on the cable and/or the (mating plug connector do not act on at least one contact partner of the (mating) plug connector or the connection between the shielding of the line and the housing of the (mating) plug connector that can disadvantageously lead to an interruption of the electrical contacting.

A generic plug connector is known from DE 10 200 9 016 227 [U.S. Pat. No. 8,323,055]. The invention relates to a plug connector that connects to a coaxial cable and that has an inner conductor, a braided outer conductor and an insulation between the inner conductor and the outer conductor, and also a protective sheath that surrounds these components, and a free end portion of a first tubular component is inserted between the insulation and the outer conductor of the coaxial cable, and a second tubular component is positively connected to the first tubular component and extends to the end of the end of the coaxial cable.

The prior art uses a slotted inner sleeve-the sleeve according to the invention is rotationally symmetrical.

The prior art only crimps the outer sleeve onto the shield-the sleeve according to the invention also crimps on the conductor jacket.

The prior art does not crimp the outer sleeve, but rather only does not provide a seal and also no strain relief. As a result, only a very weak strain relief of the plug on the shield is achieved.

According to the invention, the crimp for the electrical connection between the sleeve and the screen is produced, for example, along the sleeve at a location. Viewed further outward in the axial direction, independently of the first crimping (sleeve to shield), there is a second crimping set independently of the first crimping (sleeve to shield) that only has to provide the strain relief from the cable material and thus enables a functional relief of the screen crimping point. This makes it possible to avoid lateral or circular cable movements in the outlet region resulting from the cable being able to act directly on the crimping zone between the sleeve and the screen. This type of support (lever) reduces the possible relative movements and forces between the shield and the sleeve. This separate and thus better protection against movement in the contact zone is advantageous for functional reliability and of decisive importance. The shielding is thus implemented via the entire plug-in connection (plug-in connector and mating plug-in connector).

The invention thus relates to a shielding contact and strain relief concept, in particular for a single-wire application. The support sleeve is mounted under the shield, in particular a shielding braid, of the cable, and the shielding braid is not folded over 180° in contrast to the prior art, but runs straight in the axial direction of the cable, in particular in the plug-in direction of the plug-in connector. In addition, the outer crimp sleeve is crimped onto the cable jacket in order to guarantee additional stability with respect to strain relief and/or vibration and/or tightness.

(Mating plug-in connector with an electrically conductive housing, in which at least one contact partner is arranged and that is mounted on one end of a cable having a shield, characterized in that a support sleeve is provided, and the support sleeve is mounted under the shield, in particular a shield braid, of the cable and thus on the insulation of the electrical conductor of the cable and the shield braid is not folded over 180° in contrast to the prior art, but runs straight in the axial direction of the cable, in particular in the plug-in direction of the plug-in connector, and also an outer crimp sleeve is crimped onto the cable sheath in order to guarantee additional stability with regard to strain relief and/or vibration and/or tightness.

Option: The constructive principle according to the invention is not used in connection with a (mating) plug connector, but only in connection with the cable and/or when the cable or the (mating) plug connector is connected to a housing of an electrical device.

A further embodiment of the invention is shown with reference to the drawings, in which embodiments of the invention are illustrated in a simplified manner. Therein:

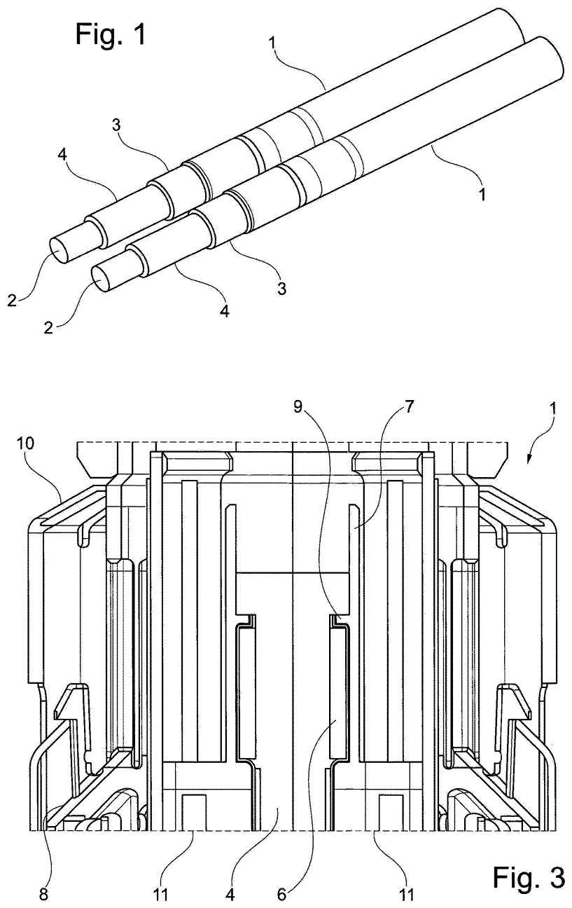

FIG. 1 shows two cables whose ends are designed according to the invention;

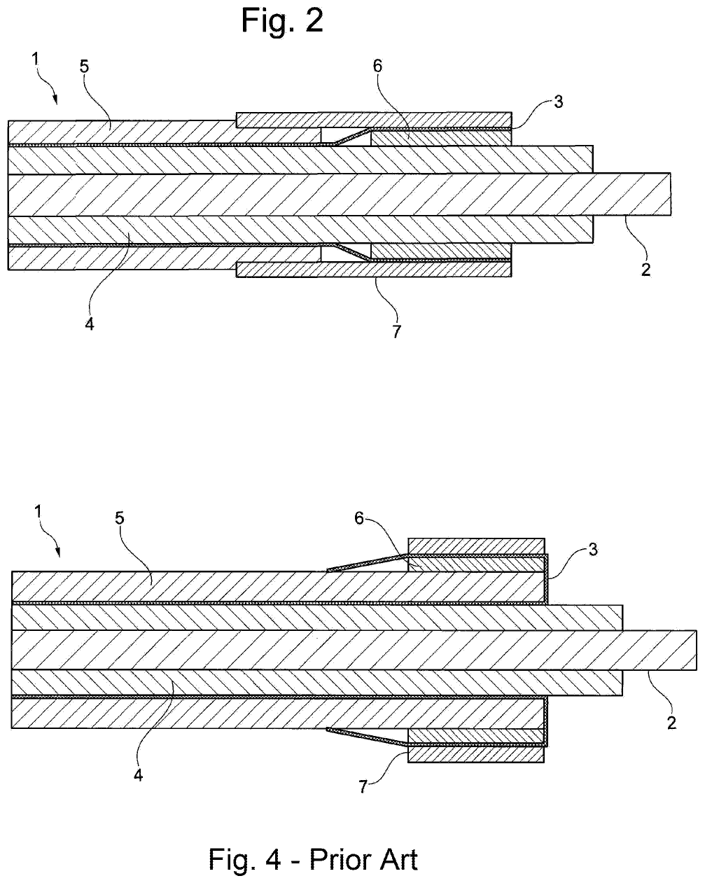

FIG. 2 shows a section through the end of a cable with a connector according to the invention;

FIG. 3 shows a plug connector with attached cable and a mating plug connector; and

FIG. 4 illustrates an assembly according to the prior art.

Referring to FIGS. 1 to 3, reference 1 designates a cable that in this embodiment is a coaxial cable and has an inner conductor 2, a shield 3, insulation 4 between the inner conductor and the shield 3 and a jacket 5 that surrounds these parts. Shortly before the end of the insulation 4, an inner support sleeve 6 is fitted on the latter and is designed in the form of a collar without a slot. The support sleeve 6 is installed between the insulation 4 and the spread shield 3. The end of the jacket 5 at the support sleeve 6 is cut back and carries an outer sleeve 7 that surrounds the extended shield 3 and the support sleeve 6. For this purpose, in order to increase strength, the outer sleeve 7 is a collar and is crimped around the end of the jacket 5 and the shield 3 together with the support sleeve 6. The support sleeve 6 can also be a crimp sleeve and can be fixed on the insulation 4. The outer sleeve 7 can be electrically conductive and is electrically connected to a housing 8 (in particular when the housing 8 consists of an electrically conductive material) and mechanically (irrespective of whether the housing 8 consists of an electrically conductive material or of an electrically non-conductive material) comes into operative connection with a housing of a mating plug connector. It is particularly advantageous if the housing 8 and also the outer sleeve 7 of the mating plug connector consist of an electrically conductive material, since it can thus be ensured that shielding is ensured via the plug connection that is formed by the plug connector and a mating plug connector.

As can be seen from FIG. 3, a free space 9 is provided into which the shield 3 extends between the end faces of the jacket 5 and the support sleeve 6. Alternatively, the outer sleeve 7 can also have a radially inwardly projecting ridge, onto which the shield 3 is placed, inserted, crimped or the like between the end faces of the jacket 5 and the support sleeve 6.

Reference 10 indicates a locking element that is actuated after the plug-in connector and a mating plug-in connector have been plugged together in order to prevent unintentional disassembly of the plug-in connection. Such a locking element 10, also referred to as a CPA, is basically known. This element 10 can consist of plastic or metallic material and generally has only a mechanical, but no electrical function.

As can also be seen from FIG. 3, the outer sleeve 7 has, at its lower end (when viewed in FIG. 3), a reinforcement region 11 that extends inward and/or outward over the cylindrical length of the outer sleeve 7 (both inward and outward in FIG. 3). Instead of such a reinforcement region 11, a straight cylindrical part, a widening, for example a frustoconical or trumpet-shaped widening or the like, is also possible. The electrical connection thereof, optionally also a mechanical connection in the sense of a guide aid, to a corresponding electrically conductive region of the mating plug connector takes place with this end region of the outer sleeve 7 in order to ensure the shielding along the plug-in connection.

Finally, FIG. 4 shows an assembly according to the prior art.

### LIST OF REFERENCES

1 Cable
2 Inner conductor
3 Shield
4 Insulation
5 Jacket
6 Inner support sleeve
7 Outer sleeve
8 Housing
9 Free space (alternatively inner collar)
10 Locking element
11 Reinforcement

1. An assembly comprising:
a connector and a cable connected thereto and having
an inner conductor,
a tubular shield,
insulation between the inner conductor and the inner shield,
a jacket surrounding the inner conductor,
shield, and insulation,
an annularly continuous inner support sleeve between the insulation and the shield at a free end portion of the cable, and
a tubular outer sleeve surrounding the shield an end section of the jacket, and the inner sleeve.

2. The assembly according to claim 1, wherein the outer sleeve is a crimp sleeve that is crimped onto the jacket and the shield with the inner sleeve

3. The assembly according to claim 1, wherein the outer sleeve has a radially inwardly projecting ridge that fits between axially confronting end faces of the jacket and the inner support sleeve and extends around the shield as far as the insulation.

4. The assembly according to claim 1, wherein between end faces of the jacket and the inner support sleeve there is a free space through which the shield passes frustoconically.

5. The assembly according to claim 3, wherein the shield passes up over an outer free end of the inner support sleeve.

6. The assembly according to the preceding claims, claim 1, wherein the inner support sleeve is crimped on the insulation.

7. The assembly according to claim 1, wherein an inner diameter of the section of the jacket in which the outer sleeve is seated and an outer diameter of the shield on the support sleeve are the same.

8. The assembly according to claim 1, wherein the inner support sleeve and the outer sleeve are electrically conductive and are connectable to an electrically conductive housing of a male or female plug connector.

9. The assembly according to claim 1, wherein the cable is a coaxial cable or a twisted pair cable.
